(19) United States
(12) Patent Application Publication
(10) Pub. No.: US 2020/0294119 A1
(43) Pub. Date: Sep. 17, 2020

(54) COMPUTER PROGRAM PRODUCT AND COMPUTER-IMPLEMENTED METHOD

(71) Applicant: TOYOTA JIDOSHA KABUSHIKI KAISHA, Toyota-shi (JP)

(72) Inventors: Tae SUGIMURA, Miyoshi-shi (JP); Naoki YAMAMURO, Nagoya-shi (JP); Hideo HASEGAWA, Nagoya-shi (JP); Kuniaki JINNAI, Nagoya-shi (JP); Takashi HAYASHI, Aichi-gun (JP)

(73) Assignee: TOYOTA JIDOSHA KABUSHIKI KAISHA, Toyota-shi (JP)

(21) Appl. No.: 16/801,274

(22) Filed: Feb. 26, 2020

(30) Foreign Application Priority Data
Mar. 14, 2019 (JP) 2019-047470

(51) Int. Cl. G06Q 30/06; G06K 9/00; H04W 4/42

(52) U.S. Cl. CPC G06Q 30/0645; H04W 4/42; G06K 9/00671

(57) ABSTRACT

A computer program product includes a non-transitory computer readable storage medium having program instructions embodied therewith. The program instructions perform a method of: determining first information based on a vehicle image included in an image, determining whether the vehicle is a booked vehicle based on the first information, and providing, with a user, second information when the vehicle is determined to be the booked vehicle, the second information indicating that the vehicle is the booked vehicle.

### INCORPORATION BY REFERENCE

The disclosure of Japanese Patent Application No. 2019-047470 filed on Mar. 14, 2019 including the specification, drawings and abstract is incorporated herein by reference in its entirety.

### BACKGROUND

### 1. Technical Field

The present disclosure relates to a computer program product and a computer-implemented method.

### 2. Description of Related Art

Conventionally, a technique related to a service in which a user rides in a vehicle as a passenger is known. One of these services is the vehicle dispatch service that is used, for example, in the taxi business. In addition to this service, other services have become known in recent years such as the ride-sharing service, in which a plurality of users rides together in a vehicle, and the on-demand bus service in which a bus travels on a route other than a predetermined route when a booking is received from users. For example, Japanese Patent Application Publication No. 2018-128773 (JP 2018-128773 A) discloses a technique used in a pickup management device that performs the user pickup management. This pickup management device receives a ride confirmation request, which includes a vehicle ID and a user ID, from an in-vehicle terminal mounted on a vehicle, determines whether the user is allowed to ride in the vehicle and, when it is determined that the user is allowed to ride in the vehicle, sends a ride permission to the in-vehicle terminal.

### SUMMARY

However, there is room for improvement in the conventional technique used for services in which a user rides in a vehicle as a passenger. For example, when there are many other vehicles in addition to the vehicle in which to ride or when there are other vehicles with similar appearance, it is not always easy for the user to identify a vehicle in which to ride.

The present disclosure improves the technique related to a service in which a user rides in a vehicle as a passenger.

A computer program product according to one embodiment of the present disclosure is a computer program product that includes a non-transitory computer readable storage medium having program instructions embodied therewith. The program instructions perform a method of: determining first information based on a vehicle image included in an image, determining whether the vehicle is a booked vehicle based on the first information, and providing, with a user, second information, which indicates that the vehicle is the booked vehicle, when the vehicle is determined to be the booked vehicle.

A computer-implemented method according to one embodiment of the present disclosure is a computer-implemented method that includes: determining first information based on a vehicle image included in an image, determining whether the vehicle is a booked vehicle based on the first information, and providing, with a user, second information when the vehicle is determined to be the booked vehicle, the second information indicating that the vehicle is the booked vehicle.

According to the computer program product and computer-implemented method according to the embodiment of the present disclosure, it is possible to improve the technique related to a service in which a user rides in a vehicle as a passenger.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a schematic configuration of an information processing system according to one embodiment of the present disclosure;

FIG. 2 is a diagram showing an example of the screen displayed on an information processing device;

FIG. 3 is a diagram showing an example of the screen displayed on the information processing device;

FIG. 4 is a block diagram showing a schematic configuration of the information processing device;

FIG. 5 is a block diagram showing a schematic configuration of a vehicle;

FIG. 6 is a block diagram showing a schematic configuration of a server;

FIG. 7 is a flowchart showing a first operation of the information processing device;

FIG. 8 is a flowchart showing a second operation of the information processing device;

FIG. 9 is a diagram showing an example of the screen displayed on the information processing device; and

FIG. 10 is a diagram showing an example of the screen displayed on the information processing device.

### DETAILED DESCRIPTION OF EMBODIMENTS

An embodiment of the present disclosure will be described in detail below.

(Configuration of Information Processing System)

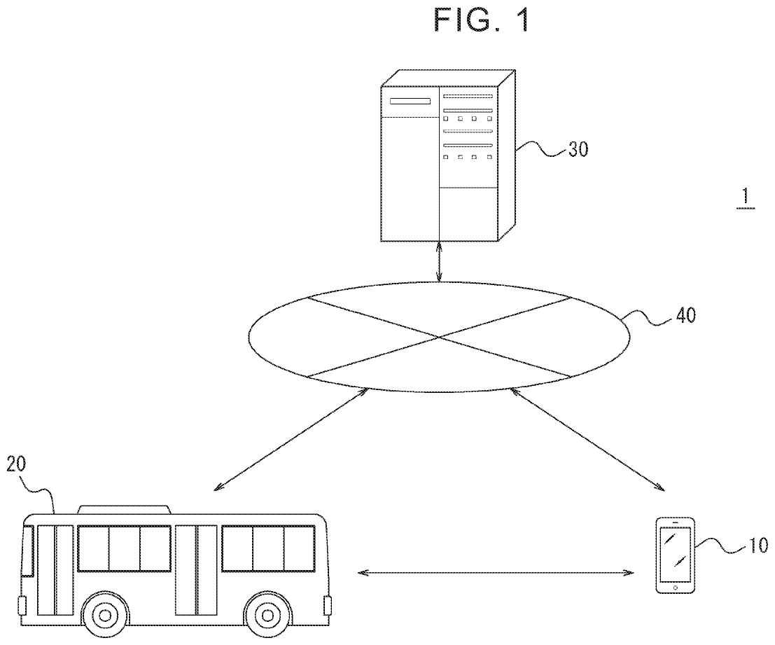

A schematic configuration of an information processing system 1 according to one embodiment of the present disclosure will be described below with reference to FIG. 1. In this embodiment, the information processing system 1 is used to provide the on-demand bus service in which a bus can travel on a route other than a predetermined route when a booking is received from the user. In the on-demand bus service, a vehicle 20 travels basically on a predetermined route cyclically but, when a booking is received from a user, the vehicle 20 may also travel exceptionally on a route other than the predetermined route (for example, a route via the pick-up/drop-off location of the user who has made a booking). However, the information processing system 1 is not limited to the on-demand bus service, and may be applied to any service in which the user rides in a vehicle as a passenger. The information processing system 1 includes an information processing device 10, a plurality of vehicles 20, and a server 30. Although only one vehicle 20 is shown in FIG. 1 for convenience of description, the information processing system 1 may include any numbers of vehicles 20. The information processing device 10, vehicle 20, and server 30 can communicate with each other via a network 40 such as a mobile communication network and the Internet. In addition, the information processing device 10 and the vehicle 20 may be capable of vehicle-to-pedestrian (V2P) communication.

The information processing device 10 is a portable device such as a mobile phone or a smartphone. However, the information processing device 10 is not limited to such a portable device and may be any information processing device. As will be described later, the information processing device 10, which includes a camera module and a display, can display on the screen a moving image obtained by capturing the sight of an object to which the camera module is directed. In FIG. 1, though only one information processing device 10 is shown for convenience of description, the information processing system 1 may include any number of the information processing devices 10.

The vehicle 20 is a passenger transport vehicle such as a bus used for the on-demand bus service. However, the vehicle 20 is not limited to such a vehicle and may be any vehicle in which the user can ride as a passenger. Although only one vehicle 20 is shown in FIG. 1 for convenience of description, the information processing system 1 may include any number of vehicles 20. The vehicle 20 may be a vehicle capable of autonomous driving. The autonomous driving includes levels 1 to 5 defined by the society of automotive engineers (SAE). However, the autonomous driving levels are not limited to these levels and any freely-defined levels may be used.

The server 30 includes one server device or a plurality of server devices that can communicate with each other. The server 30 is used, for example, by an on-demand bus service provider to manage the ride booking of the vehicle 20. More specifically, the server 30 associates a user who has made a ride booking with the specific vehicle 20 and stores the associated information. In this embodiment, “a specific vehicle 20” is the vehicle 20 (hereinafter, also referred to as “booked vehicle”) in which the user is to ride based on a ride booking. More specifically, the server 30 sends and receives any information, related to the service, to and from each of the information processing device 10 and the vehicle 20. However, the operation of the server 30 is not limited to this operation and the server 30 can perform any processing related to the service. In addition, the server 30 manages the state of the vehicle 20. More specifically, the server 30 communicates with the vehicle 20 to collect and accumulate any information on the vehicle 20, such as the position of the vehicle 20, the traveling state, and the images captured during traveling. However, the operation of the server 30 is not limited to this operation and the server 30 can perform any processing related to the state management of the vehicle 20.

First, the outline of this embodiment will be described, and details will be described later. A user who has made a ride booking can use the information processing device 10 to find the specific vehicle 20 from among a plurality of “vehicles (for example, the vehicle 20 and other vehicles traveling nearby)” or to identify whether a “vehicle” that is visible from the predetermined pickup location is the specific vehicle 20. More specifically, the information processing device 10 stores therein the comparison information (for example, the vehicle ID of the specific vehicle 20). The comparison information may be sent in advance from the server 30 to the information processing device 10. The information processing device 10 displays the moving image of a sight on the screen. When a “vehicle” is included in the moving image, the information processing device 10 extracts first information (for example, vehicle ID) from the “vehicle” included in the moving image. Based on the comparison information and the first information, the information processing device 10 determines whether the “vehicle” included in the moving image is the specific vehicle 20. After that, the information processing device 10 further displays second information (for example, the information indicating whether the vehicle is the specific vehicle 20), which is generated based on the result of determination whether the “vehicle” is the specific vehicle 20, on the screen on which the moving image is displayed.

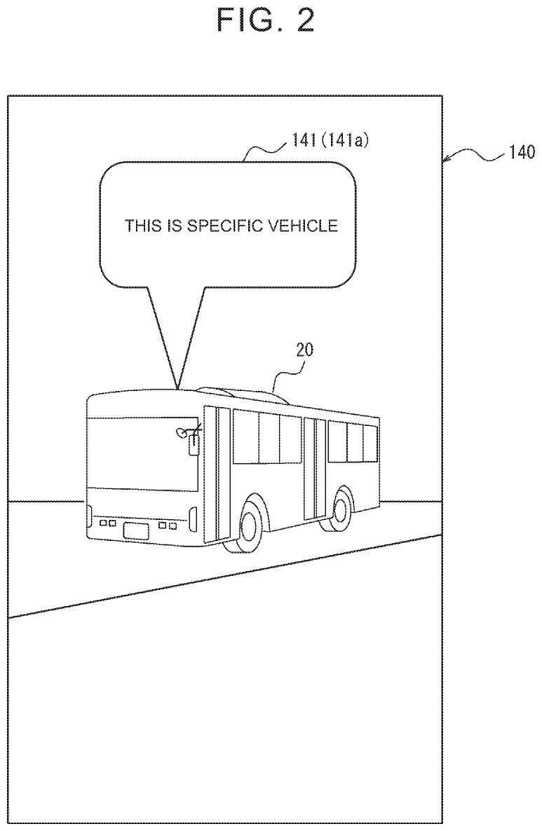

FIG. 2 shows a first example of a screen 140 of the information processing device 10 on which the moving image of a sight is displayed as described above. In this example, the camera module of the information processing device 10 is directed to the specific vehicle 20 and the specific vehicle 20 is included in the moving image. In addition to the moving image, second information 141 described above is displayed on the screen 140. More specifically, on the screen 140, a balloon-shaped image, which includes a message indicating that the “vehicle” in the moving image is the specific vehicle 20, is superimposed on the screen 140 as the second information 141a in such a way that the balloon-shaped image points to the specific vehicle 20 on the screen. In this way, the second information 141 may be superimposed on the screen 140, on which the moving image of the sight is displayed, in the so-called augmented reality (AR) mode.

This configuration allows the user to identify, at a glance, whether the “vehicle” is the specific vehicle 20 simply by looking at any “vehicle” via the information processing device 10. Therefore, this configuration increases the convenience of the service, thus improving the technique related to the service in which the user rides in a vehicle as a passenger.

The information processing device 10 may further store the information (for example, position information) on the predetermined stop locations of the specific vehicle 20. A predetermined stop location is the location where the specific vehicle 20 is to stop in order to pick up or drop off users. A predetermined stop location may be determined statically or may be determined dynamically when a booking is received from the user. For example, when a predetermined stop location is dynamically determined, there may be no object serving as a mark, such as a signboard, at the predetermined stop location. The information on a predetermined stop location may be sent in advance from the server 30 to the information processing device 10. In such a case, when the predetermined stop location is included in the moving image of the sight, the information processing device 10 further displays third information, which indicates the predetermined stop location, on the screen on which the moving image is displayed.

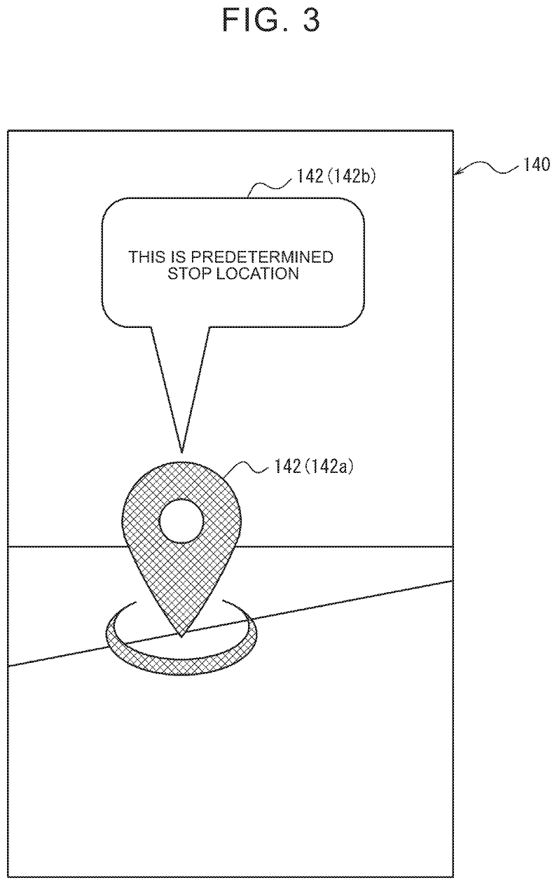

FIG. 3 shows a second example of the screen 140 of the information processing device 10 on which the moving image of a sight is displayed as described above. In this example, the camera module of the information processing device 10 is directed to a predetermined stop location where there is no object such as a signboard and only the roadside sight is included in the moving image. In addition to the moving image, third information 142 is further displayed on the screen 140. More specifically, on the screen 140, a marker image, which is provided virtually at the predetermined stop location in the moving image, and a balloon-shaped image, which includes a message indicating that the marker image is the predetermined stop location, are superimposed on the moving image, respectively, as the third information 142a and 142b.

This configuration allows the user, even when there is no object serving as a mark such as a signboard, to view a predetermined stop location through the information processing device 10 by directing the camera module of the information processing device 10 to the predetermined stop location of the specific vehicle 20. For this reason, the user can easily recognize a predetermined stop location where there is no object serving as a mark, further improving the technique related to a service in which the user rides in a vehicle as a passenger.

Next, a configuration of the information processing system 1 will be described below in detail.

(Configuration of Information Processing Device)

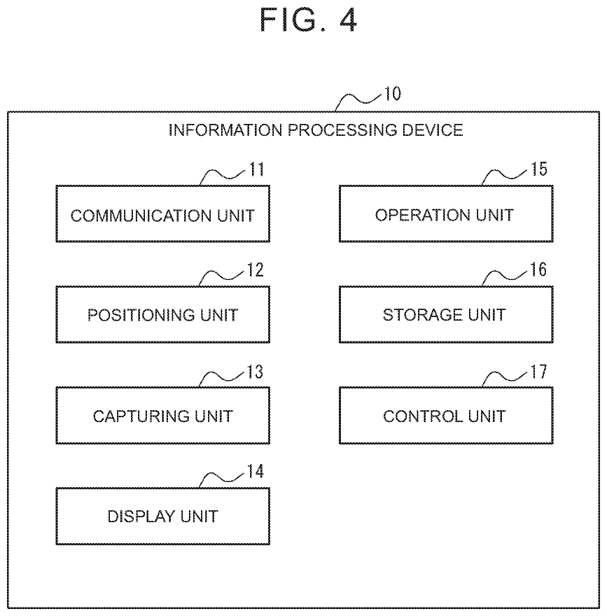

As shown in FIG. 4, the information processing device 10 includes a communication unit 11, a positioning unit 12, a capturing unit 13, a display unit 14, an operation unit 15, and a storage unit 16, and a control unit 17.

The communication unit 11 includes a communication module for connection to the network 40. This communication module supports mobile communication standards such as the 4th generation (4G) standard and the 5th generation (5G) standard or the wireless local area network (LAN) standard. However, the communication module may support not only the communication standards described above but also any wireless communication standard. In this embodiment, the information processing device 10 is connected to the network 40 via the communication unit 11. The communication unit 11 may further include another communication module that directly communicates with the vehicle 20. This communication module supports, for example, the vehicle-pedestrian communication standard, but the communication is not limited to the communication through this standard. The information processing device 10 may be able to communicate directly with the vehicle 20 via the communication unit 11 or may be able to communicate with the vehicle 20 via the network 40.

The positioning unit 12 includes a receiver compatible the satellite positioning system. Although compatible with the global positioning system (GPS), this receiver is compatible not only with the GPS but also with any satellite positioning system. The positioning unit 12 includes a gyro sensor and a geomagnetic sensor. In this embodiment, the information processing device 10 can use the positioning unit 12 to acquire the position of the device itself and the direction and the elevation angle in which the device itself faces.

The capturing unit 13 includes a camera module that generates an image obtained by capturing the sight (that is, the subject) in the field of view. In this embodiment, an “image” includes a still image and a moving image. The capturing unit 13 may be a monocular camera or a stereo camera. The capturing unit 13 is provided on the information processing device 10, for example, in such a way that the sight can be captured from the surface opposite to the display surface of the display included in the display unit 14 (that is, from the rear of the housing of the information processing device 10 that is opposite to its front).

The display unit 14 includes a display on which information is output in the form of an image. In this embodiment, an “output of information in the form of an image” means that the information is displayed on the screen in the form of text, still images, and moving images.

The operation unit 15 includes one or more interfaces for detecting an input via a user operation. For example, the interfaces included in the operation unit 15 include, but are not limited to, physical keys, capacitance keys, a touch screen integrated with the display of the display unit 14, and a microphone that accepts a voice input.

The storage unit 16 includes one or more memories. In this embodiment, a “memory” is, for example, a semiconductor memory, a magnetic memory, or an optical memory but is not limited to these memories. Each memory included in the storage unit 16 may function as the main storage device, auxiliary storage device, or cache memory. The storage unit 16 stores any information used for the operation of the information processing device 10. The storage unit 16 may store the system program and application programs. The information stored in the storage unit 16 may be updatable with the information acquired from the network 40 via the communication unit 11.

The control unit 17 includes one or more processors. In this embodiment, a “processor” is a general-purpose processor or a dedicated processor used for particular processing, but is not limited to these processors. The control unit 17 controls the whole operation of the information processing device 10.

For example, the control unit 17 stores comparison information and predetermined stop location information in the storage unit 16. The comparison information and the predetermined stop location information may be received from the server 30 via the communication unit 11 when the user completes a ride booking or may be entered by the user who has received a notification from the provider of the on-demand bus service.

In this embodiment, the “comparison information” is the vehicle ID of the specific vehicle 20 but is not limited to it. One example of the vehicle ID is the car license number on the license plate but is not limited to it. Other examples of the comparison information will be described later in the modifications of this embodiment. In this embodiment, the “information on a predetermined stop location” is the position information on a predetermined stop location (for example, latitude/longitude information) but is not limited to this information. The predetermined stop location information may include any information used for identifying a predetermined stop location.

The control unit 17 displays the moving image of a sight, captured by the capturing unit 13, on the screen of the display unit 14. This moving image is displayed almost at the same time the moving image is captured. Therefore, the user can view the sight, included in the field of view of the capturing unit 13, via the screen on which the moving image is displayed.

The control unit 17 determines whether a “vehicle (for example, the vehicle 20 or another vehicle traveling nearby)” is included in the moving image. To determine whether a “vehicle” is included in the moving image, any image recognition algorithm, such as pattern matching, feature extraction, or machine learning, may be used. An object to be recognized in image recognition may be the “vehicle” itself or an information presentation unit 23 (for example, license plate). When it is determined that a “vehicle” is included in the moving image, the control unit 17 extracts first information from the “vehicle” in the moving image. The “first information” is used in comparison with the comparison information described above. In this embodiment, the first information is the vehicle ID (for example, car license number on the license plate) but is not limited to it. Other examples of the first information will be described later in the modifications of this embodiment. To extract the first information, any image recognition algorithm, such as pattern matching, feature extraction, or machine learning, may be used.

The control unit 17 determines whether the “vehicle” in the moving image is the specific vehicle 20 based on the comparison information and the first information. In this embodiment, when the comparison information (in this example, the vehicle ID of the specific vehicle 20) matches the first information (in this example, the vehicle ID of the vehicle in the moving image), the control unit 17 determines that the “vehicle” in the moving image is the specific vehicle 20. On the other hand, when the comparison information does not match the first information, the control unit 17 determines that the “vehicle” in the moving image is not the specific vehicle 20. When it is determined that the “vehicle” is included in the moving image as described above but when the extraction of the first information has failed for some reason or other, the control unit 17 may determine that the “vehicle” is not the specific vehicle 20.

In addition, on the screen on which the moving image is displayed, the control unit 17 further displays second information based on the determination result of whether the “vehicle” in the moving image is the specific vehicle 20. In this embodiment, the “second information” is the information indicating whether the “vehicle” in the moving image is the specific vehicle 20. More specifically, when it is determined that the “vehicle” in the moving image is the specific vehicle 20, the control unit 17 displays the second information indicating that this “vehicle” is the specific vehicle 20. For example, as shown in FIG. 2, the control unit 17 further displays the second information 141a, which indicates that this “vehicle” is the specific vehicle 20, on the screen 140 on which the moving image including the “vehicle (in this example, the specific vehicle 20)” is displayed. On the other hand, when it is determined that the “vehicle” in the moving image is not the specific vehicle 20, the control unit 17 may display the second information indicating that the “vehicle” is not the specific vehicle 20 or may not have to display the second information. In displaying the second information, the control unit 17 may determine the display position of the second information 141 on the screen 140 based on the display position of the “vehicle” on the screen 140. More specifically, the control unit 17 may link the display position of the “vehicle” with the display position of the second information 141. In such a case, when the display position of the “vehicle” is changed, the display position of the second information 141 is also changed. That is, the balloon-shaped image, which includes a message indicating that the “vehicle” is the specific vehicle 20, moves in such a way that it points to the specific vehicle 20 on the screen.

When it is determined that the “vehicle” in the moving image is the specific vehicle 20 and, after that, the user enters a ride request, the control unit 17 may send the ride request, which is a request to ride in the specific vehicle 20, to the specific vehicle 20 via the communication unit 11. The ride request may be sent over the network 40 or via inter-vehicle pedestrian communication. Sending a ride request notifies the specific vehicle 20 that there is a person nearby (in this example, the user of the information processing device 10) who wants to ride.

The control unit 17 determines whether a predetermined stop location of the specific vehicle 20 is included in the moving image. To determine whether a predetermined stop location is included in the moving image, any method can be used. For example, to determine whether a predetermined stop location is included in the moving image, the control unit 17 can use the following: the position information, direction, and elevation angle of the device itself acquired by the positioning unit 12, the information (for example, the position information) on predetermined stop locations stored in the storage unit 16, and the result of any image recognition processing for the moving image (for example, recognition processing for sidewalks and roads, distance measurement processing using a monocular camera image or a stereo camera image, etc.). When it is determined that a predetermined stop location is included in the moving image, the control unit 17 may further display third information, which indicates the predetermined stop location, on the screen on which the moving image is displayed. For example, as shown in FIG. 3, third information 142 is further displayed on the screen 140 on which a moving image including a predetermined stop location is displayed.

(Configuration of Vehicle)

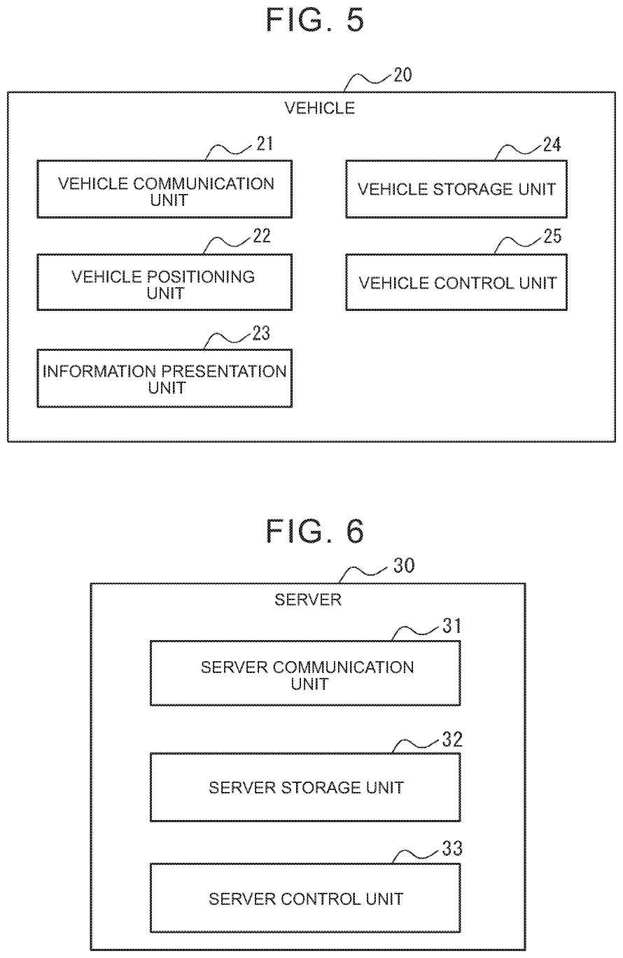

As shown in FIG. 5, the vehicle 20 includes a vehicle communication unit 21, a vehicle positioning unit 22, the information presentation unit 23, a vehicle storage unit 24, and a vehicle control unit 25. Each of the vehicle communication unit 21, vehicle positioning unit 22, vehicle storage unit 24, and vehicle control unit 25 may be built in the vehicle 20, or may be removably provided on the vehicle 20. The vehicle communication unit 21, vehicle positioning unit 22, vehicle storage unit 24, and vehicle control unit 25 are communicably connected to each other via an in-vehicle network such as a controller area network (CAN) or via a dedicated line.

The vehicle communication unit 21 includes a communication module for connection to the network 40. The communication module supports, for example, the mobile communication standard. The communication module supports not only the mobile communication standard but also any communication standard. For example, an in-vehicle communication device such as a data communication module (DCM) may function as the vehicle communication unit 21. In this embodiment, the vehicle 20 is connected to the network 40 via the vehicle communication unit 21. The vehicle communication unit 21 may further include another communication module that directly communicates with the information processing device 10. This communication module supports, for example, the vehicle-pedestrian communication standard, but the communication is not limited to the communication through this standard. The vehicle 20 may be able to communicate directly with the information processing device 10 via vehicle communication unit 21 or may be able to communicate with the information processing device 10 via the network 40.

The vehicle positioning unit 22 includes a receiver compatible with the satellite positioning system. However, this receiver is compatible not only with the GPS but also with any satellite positioning system. The vehicle positioning unit 22 includes, for example, a gyro sensor and a geomagnetic sensor. For example, a car navigation device may function as the vehicle positioning unit 22. In this embodiment, the vehicle 20 can use the vehicle positioning unit 22 to acquire the position of the host vehicle and the direction and elevation angle in which the host vehicle faces.

The information presentation unit 23 is provided on the vehicle 20 as a part of the appearance of the vehicle 20. The information presentation unit 23 is a member that presents the first information to the information processing device 10 that has captured the information presentation unit 23. For example, when the car license number of the vehicle 20 is used as the first information, the license plate may be used as the information presentation unit 23. However, the information presentation unit 23 is not limited to the license plate, and any member capable of showing or displaying the first information may be used as the information presentation unit 23. Such members include a roll sign, a head mark, a ceiling light, a display, or a dedicated member. Note that, when a member whose presentation information can be controlled (such as a roll sign or a display where the presentation information can be changed as appropriate) is used as the information presentation unit 23, the information presented by the information presentation unit 23 may be controlled by the vehicle control unit 25, for example, via the in-vehicle network. Furthermore, instead of directly showing or displaying the first information, the information presentation unit 23 may be configured in such a way that a two-dimensional code including the first information, such as a QR code (registered trademark), is printed or displayed on a part of the appearance of the vehicle 20 so that the printed or displayed two-dimensional code can be used as the information presentation unit 23. In this case, to make it easy for the information processing device 10 to recognize the information presentation unit 23 even at night, the information presentation unit 23 may emit light or may have a backlight. Similarly, to make it easy for the user to capture the information presentation unit 23 using the information processing device 10, the information presentation unit 23 may be protruded upward from the top surface of the vehicle 20.

The vehicle storage unit 24 includes one or more memories. Each memory included in the vehicle storage unit 24 may function, for example, as the main storage device, auxiliary storage device, or cache memory. The vehicle storage unit 24 stores any information used for the operation of the vehicle 20. For example, the vehicle storage unit 24 may store the system program, application programs, embedded software, map information, and the like. The information stored in the vehicle storage unit 24 may be updatable with information acquired from the network 40 via the vehicle communication unit 21. In addition, when a member that displays the first information (such as a display) is used as the information presentation unit 23 as described above, the vehicle storage unit 24 further stores the first information that will be displayed.

The vehicle control unit 25 includes one or more processors. For example, an electronic control unit (ECU) installed on the vehicle 20 may function as the vehicle control unit 25. The vehicle control unit 25 controls the whole operation of the vehicle 20. When a unit, such as a display, is used as the information presentation unit 23 as described above, the vehicle control unit 25 causes the information presentation unit 23 to display the first information stored in the vehicle storage unit 24. When a ride request is received from the information processing device 10 via the vehicle communication unit 21, the vehicle control unit 25 may notify the driver, via a display or a speaker mounted on the vehicle 20 for use by the driver and, that there is a person nearby who wants to ride. When a ride request is received by the vehicle 20 that is an autonomous vehicle, the vehicle control unit 25 may causes the vehicle 20 to stop autonomously at the next predetermined stop location on the cyclic route or to stop autonomously at any point where vehicle 20 can stop. The information on the locations where the vehicle 20 can stop may be received from the server 30 via the vehicle communication unit 21 in advance, or may be automatically determined by the vehicle control unit 25 using a sensor such as a camera, lidar, and millimeter wave radar mounted on the vehicle 20.

(Configuration of Server)

As shown in FIG. 6, the server 30 includes a server communication unit 31, a server storage unit 32, and a server control unit 33.

The server communication unit 31 includes a communication module for connection to the network 40. The communication module supports, for example, the wired local area network (LAN) standard. The communication supports not only this network standard but also any communication standard. In this embodiment, the server 30 is connected to the network 40 via the server communication unit 31.

The server storage unit 32 includes one or more memories. Each memory included in the server storage unit 32 may function, for example, as the main storage device, auxiliary storage device, or cache memory. The server storage unit 32 stores any information used for the operation of the server 30. For example, the server storage unit 32 may store the system program, application programs, map information, vehicle database, booking database, and the like.

The vehicle database stores and accumulates the information received from the vehicle 20 via the server communication unit 31, such as the information on the position of the vehicle 20, the traveling state, and the images captured during traveling. The server 30 can recognize the past or present state of the vehicle 20 by referring to the vehicle database. The booking database stores data that associates the user ID of a user who has made a ride booking with the vehicle ID of the specific vehicle 20, as well as the data on the cyclic route, predetermined stop locations, and estimated time of arrival at each predetermined stop location of the specific vehicle 20. The data stored in the booking database is not limited to these data but any information used to provide the on-demand bus service is stored. The information stored in the booking database can be changed dynamically each time a ride booking is received from the user. The information stored in the server storage unit 32 may be updatable with the information acquired from the network 40 via the server communication unit 31.

The server control unit 33 includes one or more processors. The server control unit 33 controls the whole operation of the server 30. For example, the server control unit 33 sends, via the server communication unit 31, the comparison information and the predetermined stop location information to the information processing device 10 of the user who has made a ride booking. The comparison information, which is stored in the booking database described above, is the vehicle ID of the specific vehicle 20 associated with the user. The predetermined stop location information is the information on a predetermined stop location where the user can ride in the vehicle. The server control unit 33 may further send the information on the estimated time of arrival at the predetermined stop location.

(Operation Flow of Information Processing Device)

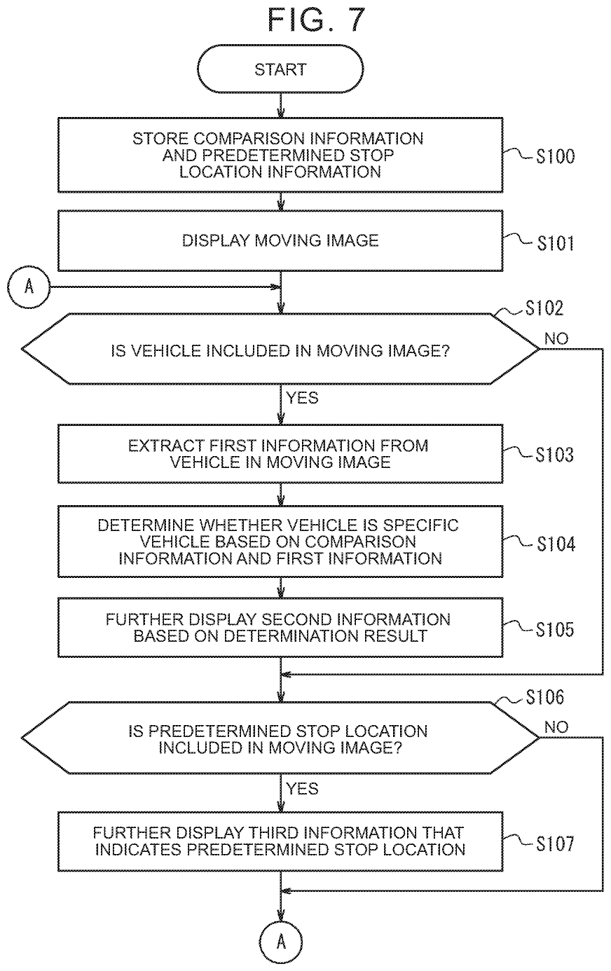

A flow of a first operation of the information processing device 10 will be described with reference to FIG. 7. In summary, the first operation is an operation for further displaying the second information and/or the third information on the screen on which the moving image of a sight is displayed.

Step S100: The control unit 17 stores comparison information and predetermined stop location information in the storage unit 16.

Step S101: The control unit 17 displays the moving image of a sight, which was captured by the capturing unit 13, on the screen of the display unit 14. The subsequent steps S102 to S107 are performed with the moving image displayed on the screen.

Step S102: The control unit 17 determines whether a “vehicle (for example, the vehicle 20 or another vehicle traveling nearby)” is included in the moving image. When it is determined that a “vehicle” is not included in the moving image (step S102—No), the processing proceeds to step S106. On the other hand, when it is determined that a “vehicle” is included in the moving image (step S102—Yes), the processing proceeds to step S103.

Step S103: The control unit 17 extracts the first information from the “vehicle” in the moving image.

Step S104: The control unit 17 determines whether the “vehicle” in the moving image is the specific vehicle 20 based on the comparison information and the first information.

Step S105: The control unit 17 further displays the second information on the screen on which the moving image is displayed, based on the determination result of whether the “vehicle” in the moving image is the specific vehicle 20.

Step S106: The control unit 17 determines whether a predetermined stop location is included in the moving image. When it is determined that a predetermined stop location is not included in the moving image (step S106—No), the processing returns to step S102. On the other hand, when it is determined that a predetermined stop location is included in the moving image (step S106—Yes), the processing proceeds to step S107.

Step S107: The control unit 17 further displays third information, which indicates the predetermined stop location, on the screen on which the moving image is displayed. After that, the processing returns to step S102.

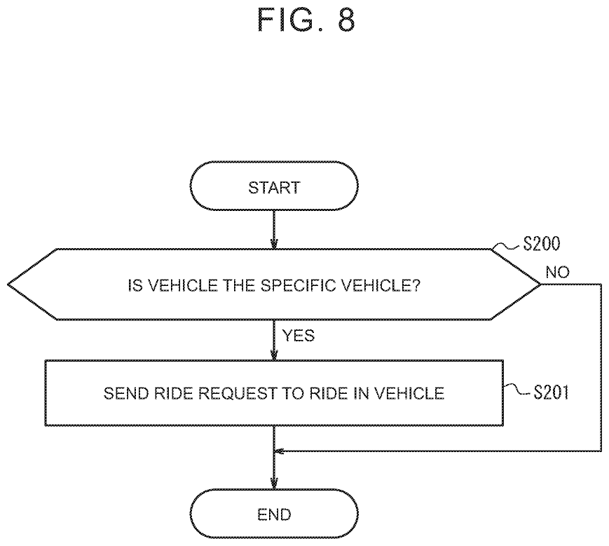

Next, a flow of a second operation of the information processing device 10 will be described with reference to FIG. 8. In summary, the second operation is an operation for sending a ride request to the specific vehicle 20 in the moving image.

Step S200: The control unit 17 confirms the determination result of whether the “vehicle” in the moving image is the specific vehicle 20 that was determined in step S104 described above. When the determination result is confirmed that the “vehicle” in the moving image is not the specific vehicle 20 (step S200—No), the processing is terminated. On the other hand, when the determination result is confirmed that the “vehicle” in the moving image is the specific vehicle 20 (step S200—Yes), the processing proceeds to step S201.

Step S201: For example, when the user enters a ride request to ride in the specific vehicle 20, the control unit 17 sends the ride request to the specific vehicle 20 via the communication unit 11. Then, the processing is terminated.

As described above, in the information processing system 1 according to this embodiment, the information processing device 10 stores the comparison information in the storage unit 16. The information processing device 10 displays the moving image of a sight, captured by the capturing unit 13, on the screen of the display unit 14. When a “vehicle” is included in the moving image, the information processing device 10 extracts the first information from the “vehicle” in the moving image. The information processing device 10 determines whether the “vehicle” in the moving image is the specific vehicle 20 based on the comparison information and the first information. Then, the information processing device 10 further displays the second information on the screen on which the moving image is displayed, based on the determination result of whether the “vehicle” in the moving image is the specific vehicle 20. This configuration allows the user to identify, at a glance, whether the “vehicle” is the specific vehicle 20 simply by looking at any “vehicle” via the information processing device 10. Therefore, this configuration increases the convenience of the service, thus improving the technique related to the service in which the user rides in a vehicle as a passenger.

Although the present disclosure has been described with reference to the drawings and embodiments, it should be noted that those skilled in the art can easily make various changes and modifications based on the present disclosure. Therefore, it is to be noted that these changes and modifications are within the scope of the present disclosure. For example, it is possible to relocate the functions included in each unit or each step in such a way that they are not logically contradictory, and it is possible to combine a plurality of units or steps into one or to divide them.

In the embodiment described above, an example was described in which each of the comparison information and the first information is a vehicle ID (for example, a car license number on a license plate). However, the comparison information and the first information are not limited to a vehicle ID.

For example, a configuration is possible in which each of the comparison information and the first information is a booking ID. More specifically, when a ride booking is received from a user, the server 30 generates a booking ID that associates the user with the specific vehicle 20, stores the generated booking ID in the booking database stored in the server storage unit 32, and sends the booking ID to each of the information processing device 10 the specific vehicle 20. The information processing device 10 stores the received booking ID, while the specific vehicle 20 presents the received booking ID as the first information via the information presentation unit 23 (such as a roll sign or a display) whose presentation information can be controlled. When the booking ID stored as the comparison information matches the booking ID extracted as the first information, the information processing device 10 determines that the “vehicle” in the moving image is the specific vehicle 20. On the other hand, when they do not match, the information processing device 10 determines that the “vehicle” in the moving image is not the specific vehicle 20. This configuration also makes it is possible to determine whether the “vehicle” in the moving image is the specific vehicle 20 as in the embodiment described above.

In addition, another configuration is also possible in which the user ID of a user is used as the comparison information and the vehicle ID is used as the first information. More specifically, when a ride booking is accepted from a user, the server 30 generates data indicating an association between the user ID of the user and the vehicle ID of the specific vehicle 20 and stores the generated data in the booking database stored in the server storage unit 32. The server 30 may send the user ID, included in this data, to the information processing device 10. The information processing device 10 stores this user ID as the comparison information. When the first information is extracted from the “vehicle” in the moving image, the information processing device 10 sends the user ID, stored as the comparison information, and the vehicle ID, extracted as the first information, to the server 30. The server 30 determines whether the booking database stores data indicating an association between the received user ID and vehicle ID and, then, sends the determination result to the information processing device 10. When the determination result indicating that there is an association between them is received from the server 30, the information processing device 10 determines that the “vehicle” in the moving image is the specific vehicle 20. On the other hand, when the determination result indicating that there is no association between them is received from the server 30, the information processing device 10 determines that the “vehicle” in the moving image is not the specific vehicle 20. This configuration also makes it is possible to determine whether the “vehicle” in the moving image is the specific vehicle 20 as in the embodiment described above.

As described above, the information processing device 10 can determine that the “vehicle” in the moving image is the specific vehicle 20 when the comparison information and the first information match or when there is a predetermined association between the comparison information and the first information.

In the embodiment described above, the example is described in which the information processing system 1 is used to provide a service, such as an on-demand bus service, that requires a prior ride booking. However, the information processing system 1 is applicable not only to this service but also to any service in which a user rides in a vehicle as a passenger. In this case, “the specific vehicle 20” is not limited to the vehicle 20 in which a user is to ride based on a ride booking (that is, a booked vehicle) but is determined according a service to which the information processing system 1 is applied.

For example, the information processing system 1 can be applied to a service in which ride booking by the user is unnecessary (such as a route bus service) and in which the vehicle 20 travels on any one of a plurality of predetermined cyclic routes. More specifically, the vehicle 20, which is a route bus, presents its own cyclic-route information (for example, a route number) as the first information using the information presentation unit 23. The information processing device 10 stores, as the comparison information, the information that indicates a user desired traveling route (for example, the cyclic-route number of the vehicle 20 that is a route bus). Then, as in the embodiment described above, the information processing device 10 determines whether the “vehicle” is the specific vehicle 20 that travels on the user desired cyclic-route based on whether the comparison information matches the first information extracted from the “vehicle” in the moving image. This configuration also allows the user to identify, at a glance, whether the “vehicle” is the specific vehicle 20 simply by looking at any “vehicle” via the information processing device 10 as in the embodiment described above.

In addition, the information processing system 1 can be applied to a service that is a ride sharing service and that does not require a user's prior ride booking. More specifically, the vehicle 20 that is used as a shared car presents the information on its own traveling route as the first information via the information presentation unit 23. The information processing device 10 stores the user's destination information as the comparison information. Then, based on whether there is a predetermined association between the comparison information and the first information extracted from the “vehicle” in the moving image, the information processing device 10 determines whether the “vehicle” is the specific vehicle 20 that will travel toward the destination of the user. The “predetermined association” in this case is an association that exists between the comparison information and the first information and that indicates that the travel route indicated by the first information is a route on which the destination indicated by the comparison information is included. This configuration also allows the user to identify, at a glance, whether the “vehicle” is the specific vehicle 20 simply by looking at any “vehicle” via the information processing device 10 as in the embodiment described above. In addition, this configuration allows the user to ride in the specific vehicle 20 by sending a ride request to the specific vehicle 20, which will travel toward the destination, without a prior ride booking.

In addition, the information processing system 1 can be applied to a service in which whether to allow the user to ride in the vehicle 20 is determined based on a user's score. As the score used in this service, a credit score in the United States or a personal score in a social credit system in China may be used, but the score is not limited to these scores. For example, a score dedicated to the information processing system 1 may be used. More specifically, the vehicle 20 presents the lower limit value of the score at which the user is allowed to ride in the vehicle as the first information via the information presentation unit 23. The information processing device 10 stores the user's score as the comparison information. Then, based on whether there is a predetermined association between the comparison information and the first information extracted from the “vehicle” in the moving image, the information processing device 10 determines whether the “vehicle” is the specific vehicle 20 in which the user is allowed to ride. The “predetermined association” in this case is an association that exists between the comparison information and the first information and that indicates that the user's score indicated by the comparison information is equal to or higher than the lower limit value indicated by the first information. This configuration also allows the user to identify, at a glance, whether the “vehicle” is the specific vehicle 20 simply by looking at any “vehicle” via the information processing device 10 as in the embodiment described above.

As described above, the “specific vehicle 20” is not limited to the vehicle 20 that has been booked as a vehicle in which the user to ride. Instead, the “specific vehicle 20” may be determined according to the service to which the information processing system 1 is applied. For example, the “specific vehicle 20” may be the vehicle 20 that travels on a cyclic route desired by the user, the vehicle 20 that travels toward the destination of the user, or the vehicle 20 in which the user is allowed to ride based on the user's score.

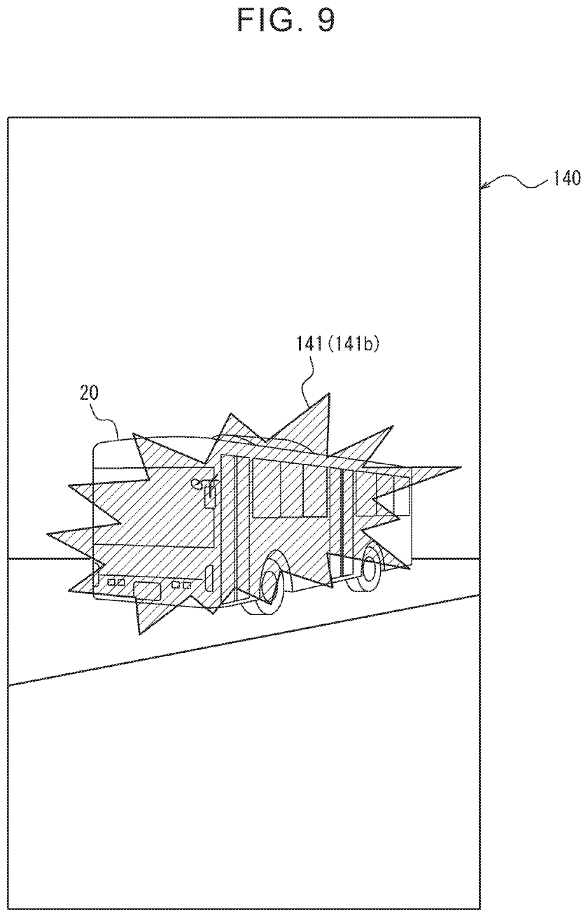

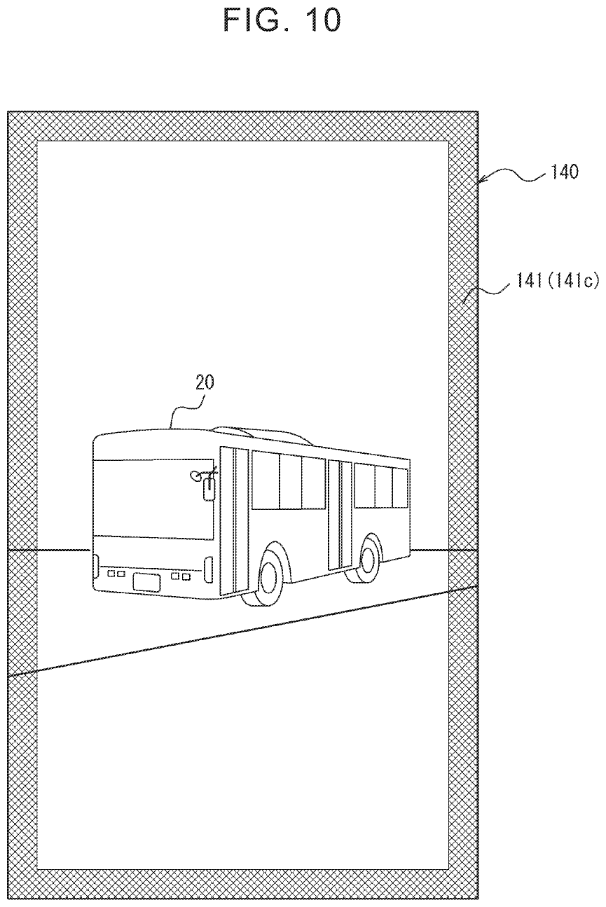

In the embodiment described above, the configuration has been described in which the display position of the second information on the screen of the information processing device 10 is determined based on the display position of the “vehicle” on the screen. More specifically, in this display mode, a balloon-shaped image is displayed as the second information 141 (141a) near the display position of the specific vehicle 20 on the screen 140 as shown in FIG. 2. However, the display mode of the second information 141 is not limited to this display mode. For example, the second information 141 may be displayed in such a way that it surrounds the “vehicle” on the screen. Furthermore, as shown in FIG. 9, a configuration is also possible in which at least a part of the second information 141 (141b), which is a marker image, is displayed in such a way that it is superimposed on at least a part of the vehicle 20 on the screen 140. The second information 141b is not limited to a marker image, and may be an image in which virtual decoration (for example, a change in the color or shape of the vehicle body) is applied to the “vehicle” on the screen. A configuration is also possible in which the display position of the second information 141 is determined regardless of the display position of the vehicle 20. For example, FIG. 10 shows a mode in which the second information 141 (141c) is displayed on the inner periphery of the screen 140. In this mode, the second information 141c may indicate whether the vehicle 20 on the screen is the specific vehicle 20 by changing its color.

A configuration is also possible in which a general-purpose information processing device, such as a mobile phone or a smartphone, operates so as to function as the information processing device 10 in the embodiment described above. More specifically, a program describing the processing for implementing each function of the information processing device 10 in this embodiment is stored in the memory of an information processing device so that the processor of the information processing device can read the program for execution. Therefore, the disclosure in this embodiment can be implemented as a program executable by a processor.

What is claimed is:

1. A computer program product comprising a non-transitory computer readable storage medium having program instructions embodied therewith, the program instructions to perform a method of:
determining first information based on a vehicle image included in an image;
determining whether the vehicle is a booked vehicle based on the first information; and
providing, with a user, second information when the vehicle is determined to be the booked vehicle, the second information indicating that the vehicle is the booked vehicle.

2. The computer program product according to claim 1, wherein
the vehicle is determined to be the booked vehicle when a comparison information matches the first information or when there is a predetermined association between the comparison information and the first information.

3. The computer program product according to claim 1, wherein the method further comprising:
providing, with the user, third information when a predetermined stop location of the vehicle is included in the image, the third information indicating the predetermined stop location.

4. The computer program product according to claim 1, wherein
the first information is determined when an information presentation unit provided on the vehicle is included in the image.

5. The computer program product according to claim 1, the method further comprising:
transferring, to the vehicle, a request information to ride on the vehicle when the vehicle is determined to be the booked vehicle.

6. The computer program product according to claim 1, the method further comprising:
displaying the vehicle image and the second information on a screen of a computer, wherein
a position of the second information on the screen is determined based on the position of a position of the vehicle image on the screen.

7. The computer program product according to claim 6, wherein
on the screen, at least a part of the second information is superimposed on at least a part of the vehicle image.

8. A computer-implemented method comprising:
determining first information based on a vehicle image included in an image;
determining whether the vehicle is a booked vehicle based on the first information; and
providing, with a user, second information when the vehicle is determined to be the booked vehicle, the second information indicating that the vehicle is the booked vehicle.

9. The computer-implemented method according to claim 8, wherein
the vehicle is determined to be the booked vehicle when a comparison information matches the first information or when there is a predetermined association between the comparison information and the first information.

10. The computer-implemented method according to claim 8, wherein the method further comprising:
providing, with the user, third information when a predetermined stop location of the vehicle is included in the image, the third information indicating the predetermined stop location.

11. The computer-implemented method according to claim 8, wherein
the first information is determined when an information presentation unit provided on the vehicle is included in the image.

12. The computer-implemented method according to claim 8, the method further comprising:
transferring, to the vehicle, a request information to ride on the vehicle when the vehicle is determined to be the booked vehicle.

13. The computer-implemented method according to claim 8, the method further comprising:
displaying the vehicle image and the second information on a screen of a computer, wherein
a position of the second information on the screen is determined based on the position of a position of the vehicle image on the screen.

14. The computer-implemented method according to claim 13, wherein
on the screen, at least a part of the second information is superimposed on at least a part of the vehicle image.
